(19) United States
(12) Patent Application Publication
(10) Pub. No.: US 2004/0145354 A1
(43) Pub. Date: Jul. 29, 2004

(54) Method for controlling an electrical discharge using electrolytes and other electrically conductive fluid materials

(76) Inventor: Walter W. Stumberger, Hightstown, NJ (US)

Correspondence Address: Walter W. Stumberger, 203 Dutch Neck Road, Hightstown, NJ, 08520, US

(21) Appl. No.: 10/756,517

(22) Filed: Jan. 14, 2004

Related U.S. Application Data
(60) Provisional application No. 60/440,858, filed on Jan. 17, 2003.

(51) Int. Cl. H02J 1/00

(52) U.S. Cl. 320/166

(57) ABSTRACT

The method of this invention uses a selected substance such as common saltwater to electrically connect electrically charged electrodes and pass electricity through the selected substance thereby discharging some or all of the electrical charge accumulated in a power system without the need for complex and un-reliable electrical triggering mechanisms.

### CROSS REFERENCE TO RELATED APPLICATIONS

This application claims priority based on U.S. Provisional Patent Application Serial No. 60/1440858, filed Jan. 17, 2003, entitled “A Method For Controlling An Electrical Discharge”, which is incorporated here by reference in its entirety.

### STATEMENT REGARDING FEDERALLY SPONSORED RESEARCH AND DEVELOPMENT

No Government funds were used to develop this invention

### BACKGROUND OF THE INVENTION

The value of quickly converting certain conductive substances, such as water (HOH) doped with a chemical like ordinary table salt (NaCl) into high pressure steam and explosive gasses through the use of a quickly applied electrical discharge is known and used in a variety of processes such as blasting rocks, drilling boreholes, and propelling projectiles.

Prior art , however, requires that the electrodes that apply the electric current be immersed in the selected substance first, with some further devices and processes requiring a trigger wire to short-circuit the electrodes and start the discharge and conversion process.

In most cases a high voltage, high current, triggering mechanism is required to control the timing and duration of the electrical discharge through the selected substance. Further the triggering mechanisms are sometimes unreliable and had shorter than desired functional lifetimes.

In this art the selected substance itself acts as the discharge causing and controlling mechanism.

This disclosure relates to electro-chemistry in various forms as well as electrical discharge systems.

A wide range of convenient substances can be used successfully in the process described here.

### SOME PRIOR ART

Some Prior Art relating to the process of using the sudden application of electrical current to convert selected substances to different and useful substances with different and useful characteristics are:

| Patent | Date | Inventor | Class |
|---|---|---|---|
| 2899864 | 08/1959 | Bloxsom | 89/7 |
| 2953353 | 09/1960 | Allen | 175/16 |
| 3143069 | 04/1964 | Ostrow et al | 102/28 |
| 3158207 | 11/1964 | Rowley | 175/16 |
| 3208647 | 09/1965 | Bailey | 299/14 |
| 3225252 | 12/1965 | Schrom et al | 315/111 |
| 3267720 | 08/1966 | Escallier | 73/12 |
| 3283294 | 11/1966 | Schrom | 166/63 |
| 3364708 | 01/1968 | Padberg, Jr. | 72/56 |
| 3500942 | 03/1970 | Smith, Jr. | 175/16 |
| 3506076 | 04/1970 | Angona | 175/57 |
| 3583766 | 06/1971 | Padberg, Jr. | 299/14 |
| 3679007 | 07/1972 | O'Hare | 175/16 |
| 3708022 | 01/1973 | Woodruff | 175/2 |
| 3840078 | 10/1974 | Allgood et al. | 175/15 |
| 4334474 | 06/1982 | Coltharp | 102/206 |
| 4343356 | 08/1982 | Riggs et al. | 166/249 |
| 4479680 | 10/1984 | Wesley et al. | 166/299 |
| 4658699 | 04/1987 | Dahn | 89/8 |
| 4741405 | 05/1988 | Moeny et al. | 175/16 |
| 4895062 | 01/1990 | Chryssomallis et al | 89/7 |
| 4897577 | 01/1990 | Kitzinger | 315/55 |
| 4974487 | 12/1990 | Goldstein et al. | 89/7 |
| 5052272 | 10/1991 | Lee | 89/7 |
| 5072647 | 12/1991 | Goldstein et al. | 89/8 |
| 5083615 | 01/1992 | McLaughlin et al. | 166/299 |
| 5106164 | 05/1992 | Kitzinger et al. | 299/14 |
| 5287791 | 02/1994 | Chaboki et al | 89/8 |
| 5425570 | 06/1995 | Wilkinson | 299/14 |
| 5482357 | 01/1996 | Wint et al | 299/14 |
| 5773750 | 06/1998 | Jae et al | 102/302 |

### BRIEF SUMMARY OF THE INVENTION

The method of this invention puts a selected substance of less electrical resistance across a gap of higher electrical resistance separating electrically charged electrodes causing electricity to pass through the selected substance and discharge some or all of the initial electrical charge on the electrodes and change the physical and chemical properties of the selected substance so as to open the circuit again. A higher level of dependability and flexibility is provided in discharging the electrical source and converting the selected substance.

### BRIEF DESCRIPTION OF THE SEVERAL VIEWS OF THE DRAWINGS

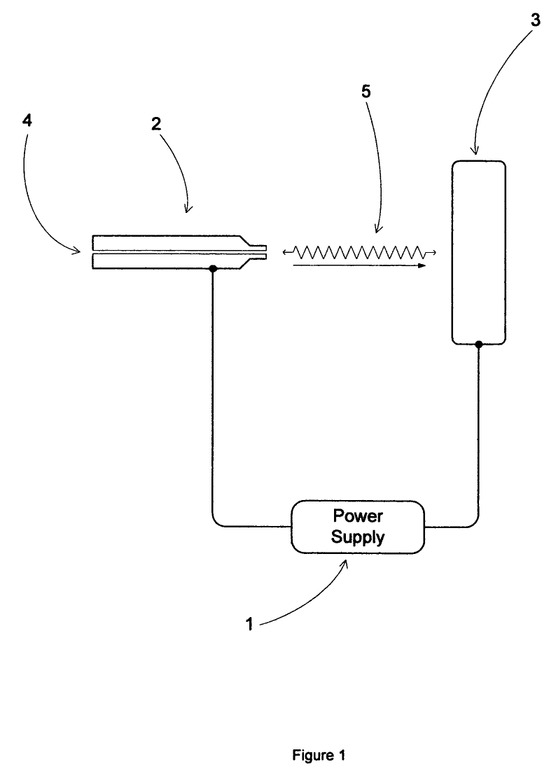

Please refer to FIG. 1.

The Power Supply (1) provides an electrical charge to the electrodes (2 and 3). A selected substance is delivered through a convenient delivery system at (4) under sufficient pressure that the selected substance is ejected from the electrode (2) and forms an electrical bridge (5) between the proximal electrode (2) and the distal electrode (3).

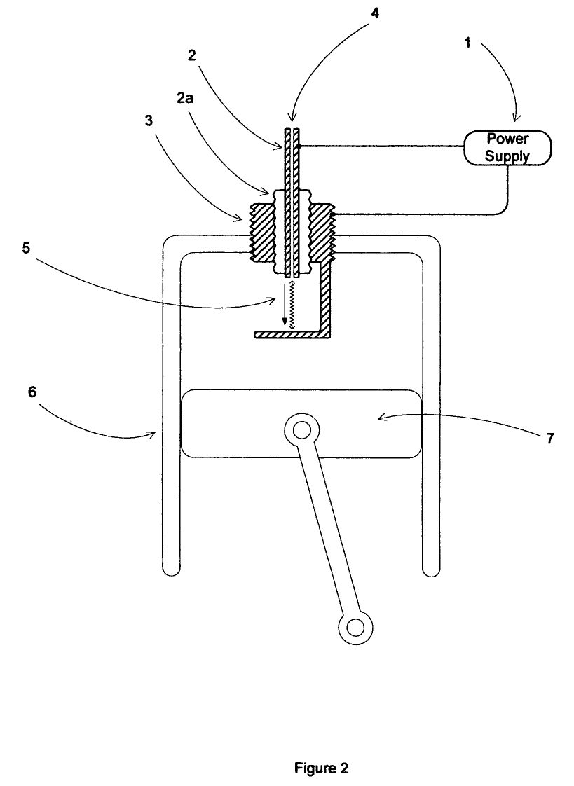

Please refer to FIG. 2, which is an embodiment.

In this embodiment the rigid container (6) supports the triggering mechanism as well as a moveable piston (7). Power Supply (1) provides an electrical charge to the electrodes (2 and 3). A selected substance is delivered through a convenient delivery system at (4) under sufficient pressure that the selected substance is ejected from the electrode (2) and forms an electrical bridge (5) between the proximal electrode (2) and the distal electrode (3) causing a flow of electricity. Insulator (2a) electrically separates the electrodes.

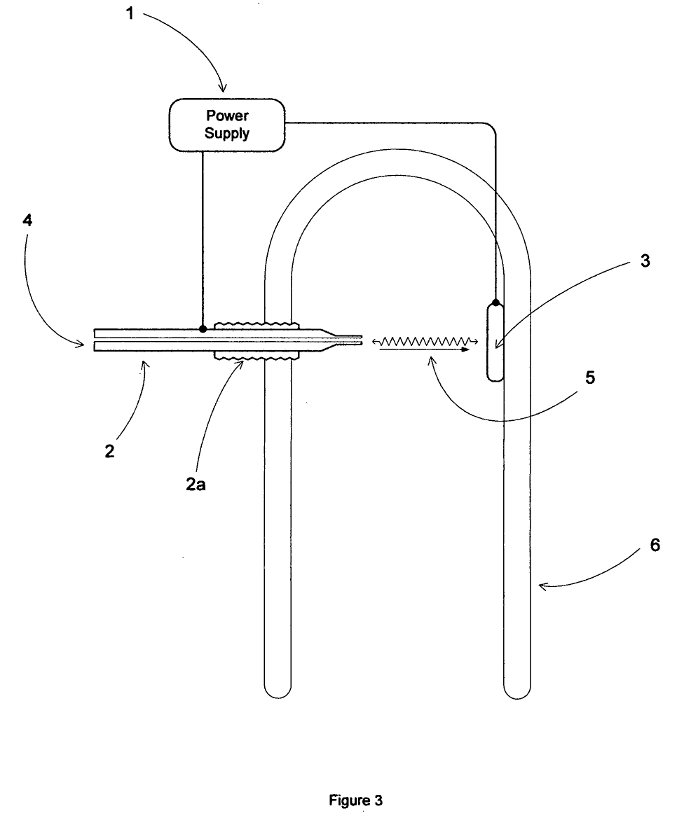

Please refer to FIG. 3, which is an embodiment.

Power Supply (1) provides an electrical charge to the electrodes (2 and 3). A selected substance is delivered through a convenient delivery system at (4) under sufficient pressure that the selected substance is ejected from the electrode (2) and forms an electrical bridge (5) between the proximal electrode (2) and the distal electrode (3) causing a flow of electricity. Insulator (2a) electrically separates the electrodes and rigid container (6) provides a means for directing any exhaust gasses.

### DETAILED DESCRIPTION OF THE INVENTION

In this method for controlling an electrical discharge a power supply provides electrical current to electrodes of convenient number, shape, size, position, attitude, and composition. One or a plurality of the electrodes have in some convenient proximity to themselves a delivery system for delivering a selected substance in such a way that the selected substance will have a close electrically conductive relation with said electrode and be able to accept the electrical condition of the proximal electrode and under some convenient force be able to enter the space between the said electrodes and extend the proximal electrode's electrical condition some convenient distance sufficiently close to the selected target electrode to provide an electrical path of less electrical resistance than the un-bridged gap between the selected electrodes and transfer some or all of the electrical charge between and among the said electrodes and thereby cause a change in the chemical composition and physical state of the selected substance resulting in dispersal of the selected substance thus eliminating the path of less resistance between the selected electrodes.

Because there are no complex or unreliable triggering mechanisms involved a higher level of dependability is achieved.

From the foregoing it will be appreciated by those skilled in the art that the presented method provides an effective and advantageous method for overcoming many of the limitations associated with discharging electrical systems.

It will also be readily appreciated by one with ordinary skill in the art to use the method of the present disclosure in other configurations.

Although certain presently preferred embodiments of the present disclosure have been described herein it will be apparent to those skilled in the art to which this disclosure pertains that modifications of the various embodiments shown herein may be made without departing from the spirit and scope and protection of this disclosure.

The attached descriptions and drawings and claims are regarded by the applicant as including a variety of individually inventive concepts, some of which may lie partially or wholly outside the scope of some or all of the claims. The fact that the applicant has chosen to restrict the claimed scope of protection in accordance with the attached claims is not to be taken as a disclaimer for alternative concepts that are included in the contents of the application and could be defined by claims differing in scope from the attached claims which different claims may be adopted at some later time.

1. is a method for discharging a charged electrical system through the introduction of a selected fluid substance of lesser resistance across a gap of higher resistance between electrically charged electrodes and
with said selected fluid substance providing an electrical connection between the said electrically charged electrodes and transferring electrical energy.

2. is a method for discharging a charged electrical system through the introduction of a selected fluid substance of lesser resistance across a gap of higher resistance between electrically charged electrodes and
with said selected fluid substance providing an electrical connection between the said electrically charged electrodes and transferring electrical energy and
with said selected substance changing its chemical and physical properties as a result of conducting said electricity and exiting the gap between the electrodes and restoring higher electrical resistance between the said electrodes.
